(19) United States
(12) Patent Application Publication
(10) Pub. No.: US 2015/0367489 A1
(43) Pub. Date: Dec. 24, 2015

(54) STAPLER

(71) Applicant: ISABERG RAPID AB, Hestra (SE)

(72) Inventor: Mattias PALMQUIST, Hestra (SE)

(73) Assignee: ISABERG RAPID AB, Hestra (SE)

(21) Appl. No.: 14/761,721

(22) PCT Filed: Jan. 9, 2014
(86) PCT No.: PCT/SE2014/000001

§ 371 Date: Jul. 17, 2015

(30) Foreign Application Priority Data
Jan. 18, 2013 (SE) 1300048-4

(51) Int. Cl. B25C 5/02; B25C 5/11

(52) U.S. Cl. CPC B25C 5/025; B25C 5/11; B25C 5/0285

(57) ABSTRACT

Stapler by which a workpiece, preferably a sheaf of papers, is stapled together, which stapler includes a base part, to which is arranged a solid anvil, and a stapler head which base part and stapler head is with a connecting device connected to each other such that they relative each other can be moved in a reciprocating stapling movement in which movement the workpiece is stapled and which movement includes a forward direction which ends at a first turning point in which the stapler head contacts the anvil and a return direction, in which the stapler head is moved away from the anvil, and which ends in a second turning point wherein the anvil is such arranged that it is elastically yielding in the direction away from the first turning point.

### TECHNICAL FIELD

The present invention relates to a stapler by which a workpiece, preferably a sheaf of papers, is stapled together, which stapler comprises a base part, to which is arranged a solid anvil, and a stapler head which base part and stapler head is with a connecting device connected to each other such that they relative each other can be moved in a reciprocating stapling movement in which movement the workpiece is stapled and which movement comprises a forward direction which ends at a first turning point in which the stapler head contacts the anvil and a return direction, in which the stapler head is moved away from the anvil, and which ends in a second turning point.

### STATE OF THE ART

Staplers of the art said above are previously known. A drawback which the known staplers have had to overcome is that the first turning point have been difficult to reach when a workpiece has been placed on the anvil. The said drawback has in the previously known staplers been solved by a compensating device arranged in the stapler head.

However all known compensating devices have been very complicated and have comprised many parts which has been complicated to mount to the stapler and to place in right positions and to secure in their positions. This has resulted in that the staplers have been expensive to manufacture and maintain since they have included parts which has been exposed to rapid wear.

### Problem

There is thus a need to provide a stapler of the kind indicated above which does not includes the said drawback which has a simple design, includes few parts, is simple to manufacture and which could easily be maintained.

### Solution

The present invention provides a stapler which overcomes the aforesaid drawback with a stapler of the kind said above which is characterized in that the anvil is such arranged that it is elastically yielding in the direction away from the first turning point.

The invention is further characterized in that the elastically yielding is created by that the base part as such consists of an elastically material.

Further is the invention characterized in that the elastically yielding is created by the anvil being arranged to the base part with a leaf spring.

Preferably is the invention characterized in that the elastically yielding is created by the anvil being arranged to the base part with a coil spring.

### BRIEF DESCRIPTION OF THE DRAWINGS

The invention will hereafter be described with references to the figures in which:

FIG. 1 is a schematically perspective view of a stapler which includes the present invention and in a start position;

FIG. 2 is a to FIG. 1 corresponding view in which the stapler is at first turning point;

FIG. 3 is a to FIG. 1 corresponding view in which a workpiece is placed on the anvil;

FIG. 4 is a view in which the stapler head is moved into contact with the workpiece;

FIG. 5 is a to FIG. 2 corresponding view in which a workpiece is stapled;

FIG. 6 is view of a base part included in the invention;

FIG. 7 is a view which shows the connection of the anvil to the base part, and

FIG. 8 shows an alternative connection of the anvil to the base part.

### PREFERRED EMBODIMENT

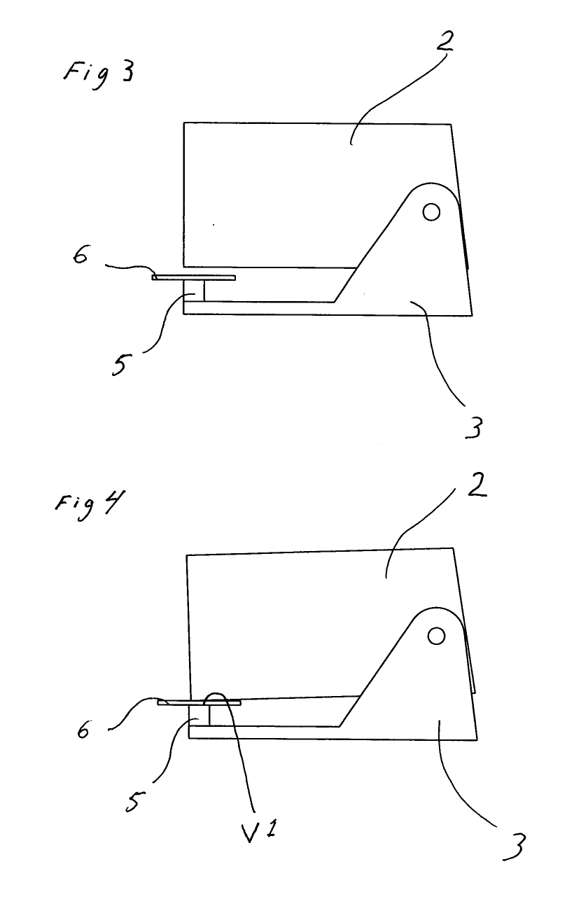

FIG. 1 discloses a stapler 1 which comprises a stapler head 2 and a base part 3. A connecting device 4 connects the stapler head and the base part to each other such that they can be moved towards and away from each other in a reciprocating stapling movement, indicated with the double arrow U. The connecting device is in the figures a shaft but the connecting device could be formed by any other device which is able to move the stapler head relative the base part in the movement indicated by the double arrow U. To the base part is arranged a solid anvil 5 on which the workpiece 6 to be stapled is placed, which is clearly disclosed by the FIGS. 3 and 4. A solid anvil is an anvil which does not consists of movable parts which moves when the bending of the staple legs occur. The stapler head includes staples for the stapling of the workpiece and a driver for driving of the staples into the workpiece. This is not shown by the figures but is evident for the one skilled in the art. The figures do not show how the stapling of the workpiece is made but also this is obvious for the one skilled in the art. Further is it known for the one skilled in the art that the stapling movement is activated by a power which is either integrated in the stapler or placed outside the stapler but provided with means connected to the stapler for the execution of the stapling operation.

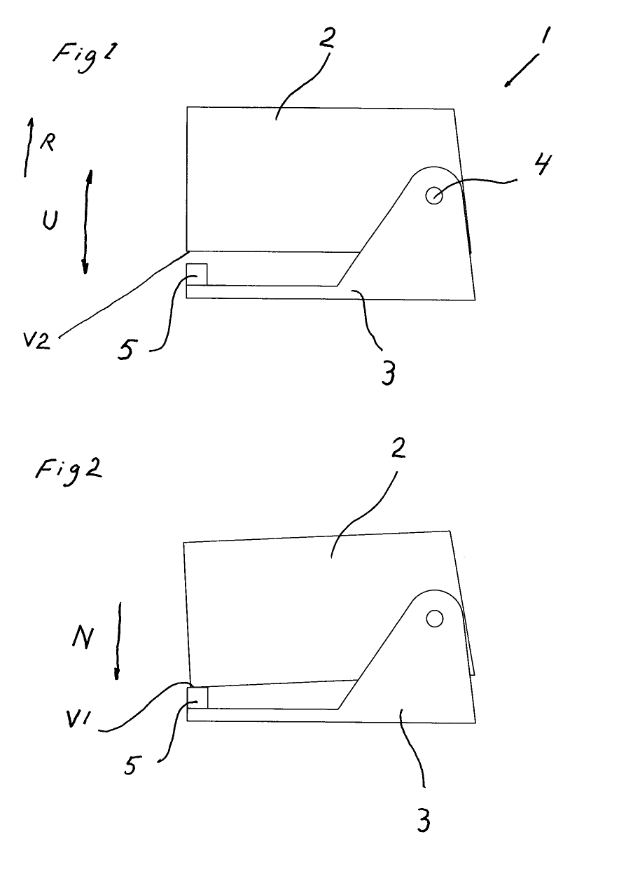

With reference to FIG. 1 and 2 the stapler 1 is in a start position in FIG. 1 in which position the stapler head 2 and the base part 3 is at a distance from each other. FIG. 2 discloses that the stapler head 2 has been moved in the double arrows U forward direction which is shown by the arrow N to a first turning point V1 in which point the stapler head contacts the anvil 5. The figures do not disclose any workpice 6 to be stapled why the stapler head easily could be moved to contact with the anvil at the turning point V1. After that the stapler head has reached the turning point V1 is the stapling of a workpice made, which is not shown in the figures but which is obvious for the one skilled in the art, and the stapler head 2 is moved in the double arrows U return direction indicated by the arrow R to the position shown in FIG. 1 and which position creates the second turning point V2 of the stapling movement.

A workpice 6 to be stapled is placed on the anvil 5 in FIGS. 3 and 4. FIG. 3 shows the stapler head 2 in a starting position comparable with the position shown in FIG. 1.

FIG. 4 shows the stapler head 2 moved in the forward direction N into contact with the workpice 6. The thickness of the workpice depends on how many sheets the workpice contains. No matter how thick the workpice is it will prevents the stapler head 2 to contact the anvil 5 at the point shown in FIG. 2 and the first turning point V1 can therefore not be reached.

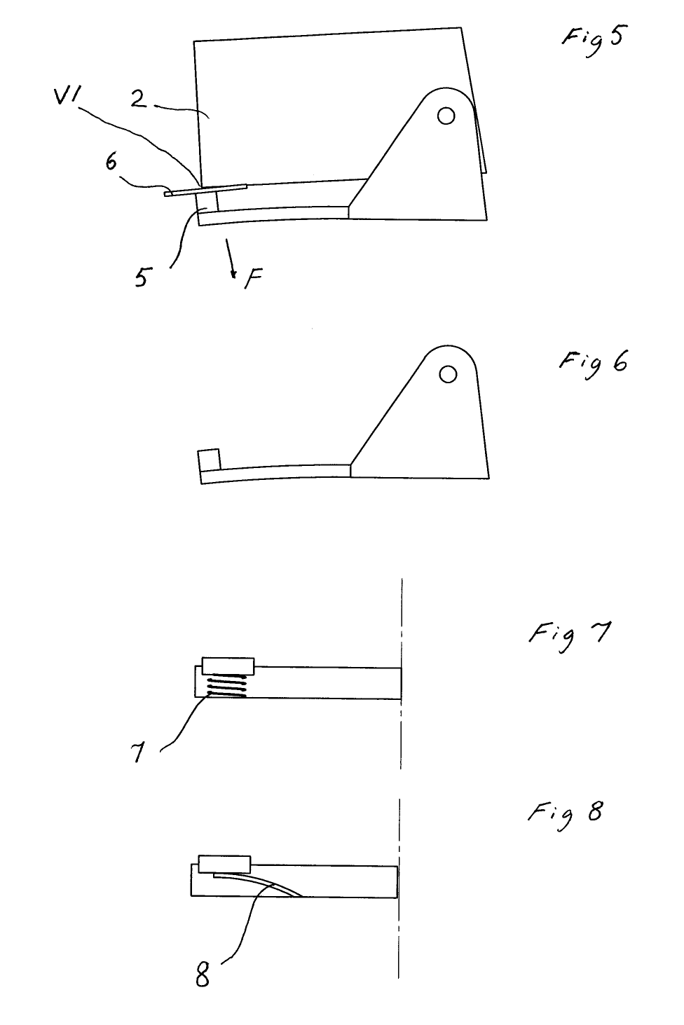

FIG. 5 discloses a view in which the base part 3 has yield in the direction indicated by the arrow F a distance which enables the stapler head 2 to reach the first turning point V1 which makes it possible for the stapler head to return to the position shown in FIGS. 1 and 3. When the stapler head has reached the position shown in FIG. 5 is the workpice stapled which is easily understood by the one skilled in the art. Due to that the base part is yieldable is it possible for the stapler head to reach the first turning point even if there is a workpice placed on the anvil. The yielding feature of the anvil can be secured by the base part as such being resilient and such a base part is shown in FIG. 6 or by connecting the anvil to the base part with a coil spring 7 which permits the anvil to move in direction F, as is shown in FIG. 7, or by connecting the anvil to the base part with a leaf spring 8 as is shown in FIG. 8.

1. Stapler (1) by which a workpiece (6), preferably a sheaf of papers, is stapled together, which stapler (1) comprises a base part (3), to which is arranged a solid anvil (5), and a stapler head (2) which base part (3) and stapler head (2) is with a connecting device (4) connected to each other such that they relative each other can be moved in a reciprocating stapling movement (U) in which movement the workpiece (6) is stapled and which movement comprises a forward direction (N) which ends at a first turning point (W1) in which the stapler head (2) contacts the anvil (5) and a return direction (R), in which the stapler head (2) is moved away from the anvil (5), and which ends in a second
turning point (V2) wherein the anvil (5) is such arranged that it is elastically yielding in the direction (F) away from the first turning point (V1).

2. Stapler (1) according to claim 1 wherein the elastically yielding is created by the base part (3) as such comprising an elastically yielding material.

3. Stapler (1) according to claim 1 wherein the elastically yielding is created by the anvil (5) being arranged to the base part (3) with a leaf spring (8).

4. Stapler (1) according to claim 1 wherein the elastically yielding is created by the anvil (5) being arranged to the base part (3) with a coil spring (7).
